(19) United States
(12) Patent Application Publication
(10) Pub. No.: US 2006/0246186 A1
(43) Pub. Date: Nov. 2, 2006

(54) Polycarboxylated polymer, method of making, method of use, and superabsorbent compositions including the same

(76) Inventors: Michael J. Nowak, Lino Lakes, MN (US); Charles W. Graves, Lake Elmo, MN (US); Wayne P. Miller, St. Paul, MN (US); Patrick D Gleason, Shoreview, MN (US)

Correspondence Address: H.B. Fuller;Patent Department, 1200 Willow Lake Blvd., P.O. Box 64683, St. Paul, MN, 55164-0683, US

(21) Appl. No.: 11/217,623

(22) Filed: Sep. 1, 2005

Related U.S. Application Data
(63) Continuation-in-part of application No. 11/116,917, filed on Apr. 28, 2005, now abandoned.

(51) Int. Cl. A23B 7/148

(52) U.S. Cl. 426/106

(57) ABSTRACT

An aqueous superabsorbent polymer precursor composition that includes a superabsorbent polymer precursor prepared by polymerizing alpha,beta-ethylenically unsaturated carboxylic acid monomers in the presence of inorganic metal salt catalyst, and an optional metal ion containing crosslinking agent, and a method of making an absorbent article that includes contacting a mesh with a slurry that includes cellulose fibers to form a wet fiber mat, removing water from the wet fiber mat, contacting the wet cellulose fiber mat with the aqueous superabsorbent polymer precursor composition, and drying the mat.

### CROSS REFERENCE TO RELATED APPLICATIONS

This is a continuation-in-part application of U.S. patent application Ser. No. 11/116,917 filed Apr. 28, 2005, and incorporated herein.

### BACKGROUND

The invention relates to aqueous superabsorbent polymer compositions, and superabsorbent polymer compositions suitable for use in food applications.

Superabsorbent polymers absorb many times their weight in water and are available in a variety of forms including, e.g., particles, films, and aqueous compositions that crosslink upon drying to exhibit superabsorbent properties. Superabsorbent polymers have been added to absorbent articles to improve various properties of absorbent articles including the total absorption and the article's rate of absorption. The liquid being absorbed is typically water or saline depending on the environment in which the article is to be used.

Superabsorbent polymers can be made by polymerizing water soluble monomers and then crosslinking the resulting polymer. If residual monomer is present in the superabsorbent polymer it may tend to leach out from the polymer. In food related applications where the superabsorbent polymer may be an indirect additive present in an article for direct food contact, residual monomer leaching is undesirable and prohibited by some Food and Drug Administration (FDA) regulations. In addition, a number of other components that are typically found in aqueous and particulate superabsorbent polymers are not acceptable for use in contact with food under some FDA regulations.

It is desirable to prepare a superabsorbent polymer that exhibits improved absorbency and is acceptable under FDA regulations for use as an indirect additive for direct contact with aqueous and fatty foods.

### SUMMARY

The invention features a method of making an absorbent article, the method including contacting a mesh with a slurry including cellulose fibers to form a wet fiber mat, removing water from the wet fiber mat, contacting the wet cellulose fiber mat with an aqueous superabsorbent polymer precursor composition including a superabsorbent polymer precursor prepared by polymerizing alpha,beta-ethylenically unsaturated carboxylic acid monomers in the presence of inorganic metal salt catalyst, and a metal ion containing crosslinking agent, and drying the mat.

In one embodiment the absorbent article includes no greater than 0.5 milligrams per square inch chloroform-soluble extractives. In other embodiments the resulting absorbent article includes less than 300 parts per million (ppm) extractable alpha,beta-ethylenically unsaturated carboxylic acid monomer. In some embodiments the alpha,beta-ethylenically unsaturated carboxylic acid monomers comprise acrylic acid monomers.

In another embodiment the resulting absorbent article includes less than 200 ppm extractable acrylic acid monomer. In other embodiments the resulting absorbent article includes less than 50 ppm acrylic acid monomer.

In one embodiment the inorganic metal salt catalyst includes ferrous sulfate.

In some embodiments the inorganic metal salt catalyst is selected from the group consisting of ferrous nitrate, ferrous chloride, ferrous ammonium sulfate and combinations thereof.

In other embodiments the inorganic metal salt catalyst is selected from the group consisting of manganese salts, magnesium salts, zinc salts, vanadium salts, calcium salts, and combinations thereof.

In another embodiment the metal ion containing crosslinking agent includes ammonium zirconyl carbonate.

In another embodiment, the aqueous superabsorbent polymer precursor composition includes at least partially neutralized polycarboxylated polymer prepared from alpha,beta-ethylenically unsaturated carboxylic acid monomers, inorganic metal salt catalyst, and from 0.1% by weight to about 10% by weight metal ion containing crosslinking agent. In some embodiments the alpha,beta-ethylenically unsaturated carboxylic acid monomers include acrylic acid monomers, and the composition, when dry, includes less than 300 ppm acrylic acid monomer. In some embodiments the composition, when dry, includes less than 50 ppm acrylic acid monomer.

In another embodiment the composition, when dry, includes no greater than 0.5 mg/in² chloroform-soluble extractives. In other embodiments the composition, when dry, includes no greater than 0.1 mg/in² chloroform-soluble extractives.

In some embodiments the inorganic metal salt catalyst includes ferrous sulfate.

In other aspects, the invention features a superabsorbent polymer prepared by drying the superabsorbent polymer precursor composition disclosed herein.

In another aspect, the invention features a solution polymer that includes polyacrylic acid polymerized in the presence of ferrous sulfate catalyst, having a pH from 5.7 to 6.3, and a solids content of no greater than 50% by weight.

In other aspects, the invention features a method of making a superabsorbent polymer precursor composition, the method including polymerizing alpha,beta-ethylenically unsaturated monomers in the presence of inorganic metal salt catalyst to form an aqueous solution polymer composition, adjusting the pH of the composition to a pH of from 5.7 to 6.3. In one embodiment, the method further includes diluting the composition with water to a solids content of no greater than 10% by weight, and adding a metal ion containing crosslinking agent. In one embodiment the metal ion containing crosslinking agent includes ammonium zirconyl carbonate.

In one embodiment the method includes adding no greater than 4% by weight of the crosslinking agent.

In one embodiment the composition, when cured, includes less than 300 parts per million alpha,beta-ethylenically unsaturated carboxylic acid monomer.

In another aspect, the invention features an absorbent article that includes a substrate including fibers, and a superabsorbent polymer formed from an aqueous superabsorbent polymer precursor composition including at least partially neutralized polycarboxylated polymer, inorganic metal salt catalyst, and a metal ion containing crosslinking agent. In some embodiments the superabsorbent polymer is formed in situ on the fibers. In one embodiment the polycarboxylated polymer is prepared from acrylic acid monomer, and the absorbent article includes no greater than 0.5 g/in² chloroform-soluble extractives and no greater than 300 ppm acrylic acid monomer.

In some embodiments the substrate of the absorbent article includes cellulose fibers and the absorbent article is in the form of paper toweling. In other embodiments, the paper toweling further includes a second substrate including cellulose fibers, the superabsorbent polymer being disposed between the first substrate and the second substrate. In other embodiments the superabsorbent polymer is in the form of a discontinuous pattern on the cellulose fiber substrate of the paper toweling.

In another embodiment the absorbent article is in the form of cellulose tissue that includes a cellulose fiber web and a superabsorbent polymer derived disclosed herein.

In some embodiments, the absorbent article exhibits a water absorbency that is at least 10% greater than the water absorbency of the article without the superabsorbent polymer composition. In other embodiments, the absorbent article includes from 1% by weight to 10% by weight superabsorbent polymer. In another embodiment the absorbent article includes from 1% by weight to about 5% by weight superabsorbent polymer.

In other embodiments, the substrate of the absorbent articles includes a nonwoven web.

In some embodiments, an absorbent article disclosed herein is made by a method that includes contacting a substrate with a first composition that includes one of i) an aqueous superabsorbent polymer composition that includes at least partially neutralized polycarboxylated polymer, and inorganic metal salt catalyst, and ii) a metal ion containing crosslinking agent, and contacting the substrate with a second composition that includes the other of i) the aqueous superabsorbent polymer composition, and ii) the metal ion containing salt crosslinking agent.

In one embodiment, an absorbent article disclosed herein is included in a food package that also includes a food substance. In one embodiment, the food substance includes at least one of meat, fish, fruit, and vegetables.

In another aspect, the invention features a method of making an absorbent article that includes contacting a substrate comprising fibers (e.g., cellulose fibers) with an aqueous solution that includes a polymer derived from alpha,beta-ethylenically unsaturated monomers and inorganic metal salt catalyst, the solution having a pH of from about 7 to about 10, and drying the substrate. In some embodiments, the solution further includes a metal ion containing crosslinking agent, e.g., comprises potassium zirconium carbonate, ammonium zirconium carbonate, or a combination thereof.

The invention features an aqueous polycarboxylated solution polymer that is suitable for use on paper, paperboard, and various cellulose-based substrates intended for contact with aqueous and fatty food substances.

The invention also features absorbent articles such as paper towels and tissues that include the superabsorbent polymer composition and that can be constructed to include only components that are generally recognized as safe under the FDA regulations (e.g., under 201(s) and 409 of the Federal Food, Drug and Cosmetics Act), meet various criteria under various FDA regulations including, e.g., 21 CFR § 170 et seq., or a combination thereof.

The invention also features a superabsorbent polymer that exhibits good water absorption capacity.

Other features and advantages will be apparent from the following description of the preferred embodiments and from the claims.

### GLOSSARY

In reference to the invention, these terms have the meanings set forth below:

The term “21 CFR § 176.170” refers to Title 21 of the Code of Federal Regulations, Volume 3, section 176.170 entitled, “Components of paper and paperboard in contact with aqueous and fatty substances,” revised as of Apr. 1, 2004.

The term “superabsorbent polymer precursor” refers to a polymer that exhibits superabsorbent properties upon crosslinking.

The term “superabsorbent” refers to the property of being able to absorb many times its weight in water.

The term “alpha,beta-ethylenically unsaturated carboxylic acid monomer” refers to alpha,beta-ethylenically unsaturated mono- and dicarboxylic acid monomer, alpha,beta-ethylenically unsaturated mono- and dicarboxylic acid anhydride monomer, and combinations thereof.

The term “inorganic metal salt catalyst” refers to a metal salt catalyst that is free of carbon atoms.

### DETAILED DESCRIPTION

The absorbent article includes superabsorbent polymer and contains less than 300 ppm, less than 200 ppm, less than 100 ppm, or even less than 50 ppm extractable alpha,beta-ethylenically unsaturated carboxylic acid monomer (e.g., acrylic acid), and preferably no greater than 0.5 milligrams per square inch (mg/in²), no greater than 0.1 mg/in², or even no greater than 0.01 mg/in² chloroform-soluble extractives as determined according to the Chloroform-Soluble Extractives Test Method. The article preferably exhibits the stated level of chloroform-soluble extractives when tested under at least one of the following conditions: water at 250° C. for two hours, heptane at 150° F. for two hours, 50% ethyl alcohol at 150° F. for two hours, and 8% ethyl alcohol at 150° F. for two hours.

The superabsorbent polymer is derived from an aqueous superabsorbent polymer precursor composition that includes a water soluble polycarboxylated polymer and, optionally, a metal ion containing crosslinking agent. The aqueous superabsorbent polymer precursor composition preferably has a pH of at least 5, at least 6, at least 7, at least 8, no greater than 12, no greater than 11, no greater than 10, or even from greater than 7 to about 10. The aqueous superabsorbent polymer precursor composition preferably is sprayable. The aqueous superabsorbent polymer precursor composition can be a gel. Preferably aqueous superabsorbent polymer precursor composition has a viscosity no greater than 3000 cP, no greater than 2000 cP, no greater than 100 cP, no greater than 50 cP no greater than 40 cP, or even no greater than about 30 cP at room temperature (i.e., about 25° C.). The superabsorbent polymer precursor composition crosslinks to form a superabsorbent polymer.

The polycarboxylated polymer is prepared by solution polymerizing alpha,beta-ethylenically unsaturated carboxylic acid monomers in the presence of an inorganic metal salt catalyst, e.g., ferrous sulfate. The dried polycarboxylated polymer includes less than 300 ppm, less than 200 ppm, less than 100 ppm, or even less than 50 ppm extractable alpha,beta-ethylenically unsaturated carboxylic acid monomer. The superabsorbent polymer derived from a polycarboxylated polymer prepared by polymerizing alpha,beta-ethylenically unsaturated carboxylic acid monomer in the presence of an inorganic metal salt catalyst exhibits good water absorption capacity. The superabsorbent polymer absorbs many times its weight in water, or even at least about 5 times its weight, at least about 10 times its weight, at least 20 times its weight, at least 50 times its weight, or even at least 100 times its weight in water.

Suitable water soluble alpha,beta-ethylenically unsaturated carboxylic acid monomers include, e.g., alpha, beta-ethylenically unsaturated mono- and dicarboxylic acids and acid anhydrides including, e.g., acrylic acid, methacrylic acid, crotonic acid, maleic acid, maleic anhydride, itaconic acid, fumaric acid and combinations thereof. The acid groups can be present, in part, as a salt including, e.g., alkali metal salts (e.g., sodium and potassium), alkaline earth metal salts, ammonium salts, and combinations thereof. The polymer can also be prepared from other water soluble monomers including monoethylenically unsaturated monomers having at least one hydrophilic radical including, e.g., monomers that include sulfonic acid groups (e.g., 2-acrylamido-2-methylpropane sulfonic acid), hydroxyl groups, amide groups, amino groups, quaternary ammonium salt groups, and ether groups. The water soluble monomers are selected such that the polymerization of such monomers produces an alkali soluble polyelectrolyte.

The polycarboxylated solution polymer can also be prepared from minor amounts of water insoluble monomer. Examples of water insoluble monomers include methylmethacrylate, n-butyl acrylate, n-butyl methacrylate, styrene, and combinations thereof. The solution polymer preferably includes less than 20% by weight, or even less than 10% by weight water insoluble monomer based on the weight of the polymer.

The inorganic metal salt catalyst is preferably ferrous sulfate. Other suitable inorganic metal salt catalysts include, e.g., ferrous nitrates, ferrous chloride, and ferrous ammonium sulfate, manganese salts, magnesium salts, vanadium salts, zinc salts, calcium salts, and combinations thereof.

Polymerization of alpha,beta-ethylenically unsaturated carboxylic acid monomers is performed in the presence of a water-soluble redox system that includes an oxidizing radical generator and a reducing agent. Examples of suitable reducing agents include erythorbic acid, erythorbic acid alkali metal salts, ascorbic acid, ascorbic acid alkali metal salts, alkali metal sulfites (sodium sulfite), alkali metal bisulfites, alkali metal hydrogen sulfite (e.g., sodium hydrogensulfite), ammonium sulfite, ammonium bisulfite, sodium metabisulfite, ammonium hydrogen sulfite, ferrous metal salts, e.g., ferrous sulfates, ferrous nitrates, ferrous chloride, and ferrous ammonium sulfate, sugars, aldehydes, primary alcohols, secondary alcohols, tertiary amines, diamines, and combinations thereof. Preferably the redox system is selected such that absorbent articles constructed to include the resulting polymer are acceptable as indirect additives for direct contact with aqueous and fatty food substances under 21 CFR 176.170. The reducing agent is present in the polymerization reaction mixture in an amount of about 0.001% by weight to 10% by weight, or even from about 0.01% by weight to 2% by weight based on the weight of polymerizable monomers.

Examples of suitable oxidizing agents include hydrogen peroxide, alkali metal persulfates (e.g., sodium persulfate), ammonium persulfate, alkylhydroperoxides, peresters, diacryl peroxides, silver salts, potassium bromate, N-bromosuccinimide, permanganates, chlorites, hypochlorites, and combinations thereof. A particularly preferred redox initiator pair is erythorbic acid and hydrogen peroxide. The oxidizing agent is present in the polymerization reaction mixture in an amount of about 0.001% by weight to 10% by weight, or even from about 0.01% by weight to 2% by weight based on the weight of polymerizable monomer.

After polymerization, the acid groups of a polycarboxylated solution polymer for use with a metal ion containing crosslinking agent preferably are neutralized to at least 50 mol %, at least 60 mol %, at least 70 mol %, no greater than 90 mol %, no greater than 85 mol %, or even no greater than 80 mol %, such that the pH of the polycarboxylated solution polymer is adjusted from a pH of about 1 to from about 4 to about 8, from 5 to 7, from greater than 5.5 to less than 6.5, from about 5.7 to 6.3, or even about 6.

After polymerization, the acid groups of a polycarboxylated solution polymer for use without a metal ion containing crosslinking agent preferably are neutralized to at least 50 mol %, at least 60 mol %, at least 70 mol %, at least 80 mol %, at least 90 mol %, at least 95 mol % or even 100 mol %, such that the pH of the polycarboxylated solution polymer is adjusted from a pH of about 1 to a pH of at least about 5, at least about 7, no greater than about 10, no greater than about 9, from about 7 to about 10, from about 7 to about 9, or even about 8.

Useful neutralizing agents include bases including, e.g., alkali metal hydroxides (e.g., sodium hydroxide and potassium hydroxide), alkaline earth metal hydroxides (e.g., calcium hydroxide and magnesium hydroxide), alkaline earth metal carbonates, metal alkoxides, and combinations thereof. Alternatively, the acid groups can be neutralized prior to polymerization, during polymerization, after polymerization, and combinations thereof.

The polycarboxylated solution polymer preferably has a viscosity suitable for use in a variety of application techniques including, e.g., spraying, saturating, soaking, coating, and combinations thereof. Preferably the solution polymer has a viscosity of from about 1 cP to about 1000 cP, from about 2 cP to about 750 cP, or even from about 5 cP to about 20 cP, at room temperature (25° C.) for a solids content of from 0.05% to about 25%.

The polycarboxylated solution polymer preferably has a solids content of from about 1% to about 65%, from about 10% to about 50%, from about 15% to about 35%, or even from about 20% to about 30%, where the term “solids” refers to the polymer. The polycarboxylated solution polymer can be diluted with water, e.g., after neutralization, to a concentration of from about 1% by weight to about 10% by weight, from about 1% by weight to about 7% by weight, from about 1% by weight to about 5% by weight solids, or even no greater than 5% by weight solids, prior to the addition of the metal ion containing crosslinking agent where present.

The optional metal ion containing crosslinking agent can be present in the aqueous superabsorbent polymer composition or can be present as a separate component. When the metal ion containing crosslinking agent is present as a separate component, it can be present on a substrate prior to applying the aqueous superabsorbent polymer composition thereto, applied to a substrate on which the aqueous superabsorbent polymer composition has previously been applied, applied simultaneously with the aqueous superabsorbent polymer composition, and combinations thereof.

The metal ion containing crosslinking agent can be applied in various forms including, e.g., as a dry component (e.g., powder, fines), in an aqueous carrier and combinations thereof. The metal ion containing crosslinking agent can also be applied to a substrate using any suitable technique including, e.g., spraying, flooding, dipping, padding, brushing, electrostatic application, and combinations thereof. If applied in an aqueous form, the metal ion containing crosslinking agent can be dried prior to application of the aqueous superabsorbent polymer composition.

Useful metal ion containing crosslinking agents are of a type and present in an amount suitable for crosslinking the polymer through its acid functionality to create a superabsorbing polymer. Suitable crosslinking agents include any substance that will react with the acid groups of the aqueous solution polymer. Crosslinking occurs as the aqueous superabsorbent polymer composition dries, and can also occur while the polymer is still an aqueous composition. It is also possible for some crosslinking reactions to occur with the functional groups (e.g., hydroxyl groups) present on fibers of the substrate on which the superabsorbent polymer composition is applied. The extent of crosslinking is directly related to the absorbent properties of the resulting superabsorbent polymer. The selection and concentration of crosslinking agent will affect the absorbent rate and capacity. It is desirable that the crosslinking agent employed “reacts” with the functional groups on the polycarboxylated polymer in less than 24 hours and at ambient (i.e., 25° C.) temperature and/or elevated temperatures.

Preferably the metal ion containing crosslinking agent is free of ethylenically unsaturated groups. A variety of metal ion containing crosslinking agents are suitable including, e.g., polyvalent metal cations capable of complexing the acid groups to render the overall polymer composite substantially insoluble yet highly swellable. The metal cations have a valence of at least three and are cations of metals belonging to the following groups of the periodic table: IIIB, IVB, VB, VIB, VIIB, VIII, IIIA, IVA, VA, and VIA. The preferred metals are aluminum, zirconium, chromium, titanium, iron, antimony and bismuth.

The polyvalent metal cation can be added to the composition in the form of a basic, acidic or neutral salt, hydroxide, or oxide. Examples of inorganic salts include chlorides, nitrates, sulfates, borates, bromides, iodines, fluorides, nitrites, perchlorates, phosphates, and sulfides, such as aluminum chloride, aluminum sulfate, ferric sulfate, ferric nitrate, antimony trichloride, bismuth chloride, zirconium chloride, chromic sulfate, and chromic nitrate. Examples of organic salts include salts of carboxylic acids such as carbonates, formates, acetates, butyrates, hexanoates, adipates, citrates, lactates, oxalates, oleates, propionates, salicylates, glycinates, glycollates and tartrates; for example, aluminum formoacetate, basic aluminum acetate, chromic acetate, aluminum citrate, aluminum diformate, aluminum triformate, titanium oxalate, ferric acetate, aluminum octate, ferric oleate, zirconium lactate, zirconium acetate, potassium zirconyl carbonate (i.e., potassium zirconium carbonate), and combinations thereof.

The ammonia and amine complexes of these metals are particularly useful. Useful amines include, e.g., morpholine, monoethanol amine, diethylaminoethanol and ethylenediamine. Examples of amine complexes include ammonium zirconyl carbonate, ammonium zirconyl glycinate, and ammonium zirconium chelate of nitrilotriacetic acid.

Other organic compounds containing polyvalent metals are also useful including, e.g., metal alkoxides, metal alkyls, and acetyl acetonates, such as aluminum isopropoxide, titanium acetyl acetonate, aluminum acetyl acetonate, chromic acetyl acetonate, zirconium ethoxide, chromic isobutoxide and triethyl aluminum.

A particularly useful metal ion containing crosslinking agent is ammonium zirconyl carbonate and ammonium zirconyl carbonate in combination with at least one of the other crosslinking agents disclosed herein including, e.g., aluminum acetate, aluminum sulfate, aluminum potassium sulfate, aluminum chloride, aluminum acetyl acetonate, chromium acetate, zirconium acetate, ferric chloride, ferric acetyl acetonate, and titanium acetyl acetonate. Ammonium zirconyl carbonate is commercially available under the trade designations BACOTE 20 and BACOTE 6200 from Magnesium Elektron, Inc. (Flemington, N.J.). Potassium zirconium carbonate is commercially available under the ZIRMEL series of trade designations including ZIRMEL M and ZIRMEL 1000 from Magnesium Elektron, Inc.

The crosslinking agent is preferably present in the aqueous superabsorbent polymer precursor composition in an amount of no greater than about 20% by weight, no greater than about 10% by weight, no greater than about 5% by weight, no greater than about 3% by weight, at least 2% by weight, or even at least 0.1% by weight based on the weight of the polymer.

The absorbent article can include a variety of substrates including, e.g., fibrous woven and nonwoven substrates (e.g., webs) prepared from various fibers including, e.g., air laid fibers, meltblown fibers, spunbond fibers, staple fibers, carded fibers, and combinations thereof. Suitable fibers include natural and synthetic fibers including, e.g., cellulose fibers, cotton, wood pulp fibers, wood pulp fluff, microcrystalline cellulose, bicomponent fibers, and combinations thereof. Examples of suitable synthetic fibers prepared from thermoplastic polymers include, e.g., polyolefins, polyamides, polyester, polyurethane, polyvinyl alcohol, polycaprolactone, styrene butadiene block copolymers, and combinations thereof. Examples of suitable polyolefins include polyethylene, polypropylene, polybutylene, copolymers of ethylene and other alpha-olefins, copolymers of propylene and other alpha-olefins, copolymers of butylene and other alpha-olefins and combinations thereof. The fiber webs can be formed using any suitable technique for depositing fibers to form a web or layer including, e.g., carding, garneting, airlaying, wet laying, and combinations thereof.

The aqueous superabsorbent polymer precursor composition can be applied to a substrate using any suitable technique including, e.g., spraying, flooding, dipping, padding, brushing, electrostatic application, and combinations thereof. The composition can be applied as continuous or discontinuous coating, in the form of a pattern or randomly. The aqueous superabsorbent polymer precursor composition can be applied during the formation of a substrate, to an existing substrate, and combinations thereof. During paper manufacturing, for example, methods of applying the precursor composition include, e.g., applying the precursor composition to the slurry of fibers, applying the precursor composition after the paper is formed on a wire mesh but before the paper is consolidated between squeeze rollers, applying the precursor composition after the paper has been dried during, e.g., a conventional coating step, and combinations thereof.

A useful method of making an absorbent article includes applying the superabsorbent polymer precursor composition to a cellulose fiber web such as paper toweling or tissue. The cellulose fiber web is in the form of a thin sheet, e.g., having a basis weight no greater than about 100 g/m², from about 3 g/m² to about 35 g/m², or even from about 15 g/m² to about 20 g/m².

The superabsorbent polymer composition and articles that include the superabsorbent polymer can be constructed to include multiple layers of the same or different substrates and in the form of or incorporated into a variety of absorbent articles including, e.g., tissue and wipes including, e.g., facial tissue, paper towels, and wet-wipes, diapers, training pants, swim wear, absorbent underpants, baby wipes, adult incontinence products, feminine hygiene products, medical absorbent garments, drapes, gowns, bandages, wound dressings, underpads, wipes, and food packaging including, e.g., wraps, absorbent pads (e.g., for meat (e.g., beef, poultry, lamb, pork, deer, elk and bison), fish, fruit, vegetables, and flowers) and bags.

The aqueous superabsorbent polymer precursor composition is particularly suitable for application to cellulose substrates such as tissue and paper towels at add on weights of at least 1% by weight, at least about 2% by weight, at least about 3% by weight, no greater than about 10% by weight, no greater than about 9% by weight, from about 3% by weight to about 10% by weight, or even from about 3% by weight to about 8% by weight dried superabsorbent polymer based on the weight of the dry article. Useful absorbent articles formed from the aqueous superabsorbent polymer precursor composition preferably include less than 300 ppm, less than 200 ppm, less than 100 ppm, or even less than 50 ppm extractable alpha,beta-ethylenically unsaturated carboxylic acid monomer, and preferably less than 0.5 mg/in², no greater than 0.1 mg/in², or even no greater than 0.01 mg/in² chloroform-soluble extractives.

The invention will now be described by way of the following examples.

### EXAMPLES

Test Procedures

Test procedures used in the examples include the following.

Extractable Monomer Test Method

The amount of extractable acrylic acid monomer is determined using high performance liquid chromatography (HPLC) according to the following method. A 20 microliter (uL) sample is injected onto a 4 um particle size C₁₈ column, e.g., SYNERGY 4U HYDRO-RO 150×46 mm column, designed to be used with a 100% aqueous mobile phase, that has been equilibrated with a mobile phase of 100% 20 mM potassium phosphate buffer having a pH of 2.5 at a flow rate of 1 mL/minute. The column temperature is maintained at 40° C. and the run time is 10 minutes. The ultraviolet/visible light detector is set at 210 nm.

Calibration standards are prepared by diluting an acrylic acid monomer stock solution having a concentration of 1000 ug/mL (glacial acrylic acid/deionized water) as follows: 1 mL stock to 100 mL deionized water, 1 mL stock to 50 mL, 5 stock to 100 mL, 5 mL stock to 50 mL and 5 mL stock to 10 mL corresponding to the following standard concentrations: 0.1 μg/mL, 0.2 μg/mL, 0.5 μg/mL, 1 μg/mL and 5 μg/mL. The calibration standards are filtered through a 0.45 um syringe filter. The standards are placed in vials and two injections of each standard are made on the HPLC to create the calibration curve.

Sample Preparation

A 10 cm strip of dialysis membrane having a molecular weight cut off of 100 Daltons is rinsed with deionized water. One end is sealed with a clip or by tying a knot in the end of it. The other end is opened and placed upright in a beaker. From 1.0 g to 1.3 g of sample (accurately weighed) is placed in the dialysis membrane. The open end of the membrane is sealed with a clip or by tying a knot. The sample is placed in a 250 mL beaker and approximately 80 mL of deionized water is added. The beaker is covered with a watch glass and stirred for seven hours at room temperature.

The dialysis membrane and sample are removed from the beaker, the remaining solution is quantitatively transferred to a 100 mL volumetric flask, diluted to the 100 mL mark with deionized water, and mixed. The solution is then filtered through a 0.45 um syringe filter.

The sample is placed in a vial and two injections per vial are sequentially made onto the HPLC.

A spiked sample of 100 ppm is also prepared. The spiked sample is run with the sample. The acceptable spike recovery range is from 80% to 120%.

The concentration of acrylic acid monomer in the sample is calculated as follows

$$conc . acrylic acid = \frac{( μ g / mL acrylic acid ) ( dilution volume )}{sample weight}$$

and reported in units of ppm.
Modified Extractable Monomer Test Method

The amount of extractable alpha,beta-ethylenically unsaturated carboxylic acid monomer other than acrylic acid monomer is determined according to the following method. A 20 microliter (uL) sample is injected onto a 4 um particle size C₁₈ column, e.g., SYNERGY 4U HYDRO-RO 150×46 mm column, designed to be used with a 100% aqueous mobile phase, that has been equilibrated with a mobile phase of 100% 20 mM potassium phosphate buffer having a pH of 2.5 at a flow rate of 1 mL/minute. The column temperature is maintained at 40° C. and the run time is 10 minutes. The ultraviolet/visible light detector is set at 210 nm.

Calibration standards are prepared by diluting a alpha,beta-ethylenically unsaturated carboxylic acid monomer stock solution having a concentration of 1000 ug/mL (alpha,beta-ethylenically unsaturated carboxylic acid/deionized water) as follows: 1 mL stock to 100 mL deionized water, 1 mL stock to 50 mL, 5 stock to 100 mL, 5 mL stock to 50 mL and 5 mL stock to 10 mL corresponding to the following standard concentrations: 0.1 μg/mL, 0.2 μg/mL, 0.5 μg/mL, 1 μg/mL and 5 μg/mL. The calibration standards are filtered through a 0.45 um syringe filter. The standards are placed in vials and two injections of each standard are made on the HPLC to create the calibration curve.

Sample Preparation

A 10 cm strip of dialysis membrane having a molecular weight cut off of 100 Daltons is rinsed with deionized water. One end is sealed with a clip or by tying a knot in the end of it. The other end is opened and placed upright in a beaker. From 1.0 g to 1.3 g of sample (accurately weighed) is placed in the dialysis membrane. The open end of the membrane is sealed with a clip or by tying a knot. The sample is placed in a 250 mL beaker and approximately 80 mL of deionized water is added. The beaker is covered with a watch glass and stirred for seven hours at room temperature.

The dialysis membrane and sample are removed from the beaker, the remaining solution is quantitatively transferred to a 100 mL volumetric flask, diluted to the 100 mL mark with deionized water, and mixed. The solution is then filtered through a 0.45 um syringe filter.

The sample is placed in a vial and two injections per vial are sequentially made onto the HPLC.

A spiked sample of 100 ppm of the alpha,beta-ethylenically unsaturated carboxylic acid monomer is also prepared. The spiked sample is run with the sample. The acceptable spike recovery range is from 80% to 120%.

The concentration of alpha,beta-ethylenically unsaturated carboxylic acid monomer in the sample is calculated as follows

$$conc . alpha , beta \text{-} ethylenically unsaturated carboxylic acid = \frac{\begin{matrix}( μg \text{/} mL alpha , beta \text{-} ethylenically unsaturated carboxylic acid ) \\ ( dilution volume )\end{matrix}}{sample weight}$$

and reported in units of ppm.
Chloroform-Soluble Extractives Test Method

The amount of chloroform-soluble extractives is determined according to the Extractives Test Method disclosed in 21 CFR 176.170 for food contact surface of uncoated or coated paper and paperboard, pages 201-205, Apr. 1, 1998 Edition, and incorporated herein. The conditions for determining the amount of chloroform-soluble extractives are at least one of: water at 250° C. for two hours, heptane at 150° F. for two hours, 50% ethyl alcohol at 150° F. for two hours, and 8% ethyl alcohol at 150° F. for two hours. The results are reported in mg/in².

% Solids

The percent solids in a composition is determined by first weighing an aluminum weighing dish to the nearest milligram. The composition to be tested is mixed or stirred to insure homogeneity. One gram +/−0.2 grams of the composition is added to the dish and dried in an oven for 1.5 hour to 2.5 hours at a temperature of 130° C. The sample is cooled for approximately 5 minutes and reweighed. The dried weight is recorded. An average of the dried weight of at least two samples not differing by more than 0.3% is recorded and % solids is calculated as follows:

$$\% solids = \frac{dry weight}{wet weight} * 100.$$

Viscosity

Viscosity is determined using a Brookfield Viscometer Model RVF at 25° C. and 20 rotations per minute using an appropriate spindle for the viscosity in accordance with the viscometer manufacturer's instructions.

pH

The pH of a composition is determined using a pH meter at 25° C. in accordance with the manufacturer's instructions.

Water Absorption Capacity

A polymer composition and crosslinker composition are combined and mixed until uniform. A cellulosic substrate that has been dried at 350° F. for 5 minutes and weighed is then submerged in the composition and each side of the substrate is bathed for fifteen seconds. The samples are then placed on a drying rack and allowed to air dry. The air dried samples are then heat pressed at 350° F. for 30 seconds and then cured in an oven at 350° F. for 15 minutes. The cured samples are then weighed to determine the % add-on. The samples are then cut into 3 in×2.5 in samples. The weight of each small cured sample is determined and recorded. The samples are then submerged in deionized water for one minute. Each sample is then reweighed to determine its absorbency in terms of grams of water per gram of fiber.

Preparation of Polyacrylic Acid

A reactor is charged with 1097.4 g deionized water and heated to 70° C. under a nitrogen purge. When the reactor reaches 70° C., the nitrogen purge is shut off and 3.96 g 50% hydrogen peroxide and 0.08 g ferrous sulfate are sequentially added to the reactor. After 5 minutes, an acrylic acid monomer feed is started and continued uniformly for 2.75 hours. A delayed oxidizer feed of 42.2 g water and 3.78 g hydrogen peroxide and a delayed reducer feed of 43.10 g deionized water and 2.87 g erythorbic acid are then uniformly fed into the reaction vessel over a period of three hours and 25 minutes. The batch temperature is maintained at a temperature of from 70° C. to 75° C. during the feeds and for 30 minutes after the catalyst feed is finished. The reaction mixture is then treated with 4.13 g deionized water followed by a delay of 15 minutes, 0.51 g Aztec T-BHP-70 70% tert-butyl hydroperoxide (Aztec Peroxide, Inc., Elyra, Ohio) followed by a delay of 15 minutes, 4.13 g deionized water followed by a delay of 15 minutes, 0.35 g erythorbic acid followed by a delay of 15 minutes, 4.13 g deionized water followed by a delay of 15 minutes, 0.51 g Aztec T-BHP-70 tert-butyl hydroperoxide (Aztec Peroxide, Inc.) followed by a delay of 15 minutes, 4.13 g deionized water followed by a delay of 15 minutes, 0.35 g erythorbic acid followed by a delay of 15 minutes. A neutralizing agent in the form of 291.83 g of 50% caustic soda is then added to the reaction vessel after which 127.40 g water and 3.39 g PROXEL GXL antimicrobial are added. The resulting polyacrylic acid solution polymer has a pH of 6.0 and a solids content of approximately 25%.

Control

A cellulose substrate having a basis weight of 80 g/m² is tested according to the Water Absorption Capacity Test Method. The expected grams of water absorbed per gram of fiber (g H₂O/g fiber) is reported in Table 1.

### Examples 1-7

The 25% solids polyacrylic acid is diluted with deionized water to a 3.33% solids solution. A series of superabsorbent polymer precursor compositions (Examples 1-7) are prepared by combining an approximately 30% solids BACOTE 20 ammonium zirconyl carbonate composition (Magnesium Elektron, Inc, Flemington, N.J.) and the 3.33% solids polyacrylic acid in the amounts specified in Table 1, which are specified on a solids basis. Each composition is applied to a cellulose substrate having a basis weight of 80 g/m² at the add on weight specified in Table 1 and dried.

### Example 8

The 25% solids polyacrylic acid is adjusted to a pH of 8.0 with sodium hydroxide. The composition is then diluted with deionized water to a 3.33% solids solution. The composition is applied to a cellulose substrate having a basis weight of 80 g/m² at an add on weight of 5% and dried.

Examples 1-8 are tested according to the Water Absorption Capacity Test Method. The expected grams of water absorbed per gram of fiber (g H₂O/g fiber) and per gram of superabsorbent polymer (g H₂O/g SAP) is reported in Table 1.

Examples 1, 4 and 8 are tested according to the Chloroform-Soluble Extractives Test Method under each of the recited conditions and the expected results are set forth in Table 2.

TABLE 1

| | | % Polyacrylic | | g H₂O/g | g H₂O/g |
|---|---|---|---|---|---|
| Sample | % BACOTE | Acid | % add on | fiber | SAP |
| Control 1 | 0 | 0 | 0 | 2.33 | — |
| Example 1 | 2.5 | 97.5 | 5 | 2.79 | 9.2 |
| Example 2 | 3 | 97 | 5 | 3.19 | 17.2 |
| Example 3 | 5 | 95 | 5 | 2.93 | 12 |
| Example 4 | 10 | 90 | 5 | 3.05 | 14.4 |
| Example 5 | 20 | 80 | 5 | 2.92 | 11.8 |
| Example 6 | 10 | 90 | 7.5 | 2.80 | 6.27 |
| Example 7 | 20 | 80 | 7.5 | 2.50 | 2.27 |
| Example 8 | 0 | 100 | 5 | 3.07 | 14.8 |

TABLE 2
Chloroform-Soluble Extractives

| | Water | Heptane | 50% Alcohol | 8% Alcohol |
|---|---|---|---|---|
| Sample | (mg/in²) | (mg/in²) | (mg/in²) | (mg/in²) |
| Example 1 | 0.01 | 0.003 | <0.01 | <0.01 |
| Example 4 | 0.01 | 0.002 | <0.01 | <0.01 |
| Example 8 | 0.01 | 0.002 | 0.01 | 0.01 |

Other embodiments are within the claims.

What is claimed is:

1. A method of making an absorbent article, said method comprising
contacting a mesh with a slurry comprising cellulose fibers to form a wet fiber mat;
removing water from said wet fiber mat;
contacting said wet cellulose fiber mat with an aqueous superabsorbent polymer precursor composition comprising
a superabsorbent polymer precursor prepared by polymerizing alpha,beta-ethylenically unsaturated carboxylic acid monomers in the presence of inorganic metal salt catalyst, and
a metal ion containing crosslinking agent; and
drying said mat.

2. The method of claim 1, wherein said absorbent article comprises no greater than 0.5 milligrams per square inch chloroform-soluble extractives.

3. The method of claim 1, wherein the resulting absorbent article comprises less than 300 ppm extractable alpha,beta-ethylenically unsaturated carboxylic acid monomer.

4. The method of claim 1, wherein said alpha,beta-ethylenically unsaturated carboxylic acid monomers comprise acrylic acid monomers.

5. The method of claim 4, wherein the resulting absorbent article comprises less than 200 ppm extractable acrylic acid monomer.

6. The method of claim 4, wherein the resulting absorbent article comprises less than 50 ppm acrylic acid monomer.

7. The method of claim 1, wherein said inorganic metal salt catalyst comprises ferrous sulfate.

8. The method of claim 1, wherein said inorganic metal salt catalyst is selected from the group consisting of ferrous nitrate, ferrous chloride, ferrous ammonium sulfate and combinations thereof.

9. The method of claim 1, wherein said inorganic metal salt catalyst is selected from the group consisting of manganese salts, magnesium salts, zinc salts, vanadium salts, calcium salts, and combinations thereof.

10. The method of claim 1, wherein said metal ion containing crosslinking agent comprises ammonium zirconyl carbonate.

11. An aqueous superabsorbent polymer precursor composition comprising:
at least partially neutralized polycarboxylated polymer prepared from alpha,beta-ethylenically unsaturated carboxylic acid monomers;
inorganic metal salt catalyst; and
from 0.1% by weight to about 10% by weight metal ion containing crosslinking agent.

12. The composition of claim 11, wherein said alpha,beta-ethylenically unsaturated carboxylic acid monomers comprise acrylic acid monomers and wherein said composition, when dry, comprises less than 300 ppm acrylic acid monomer.

13. The composition of claim 12, wherein said composition, when dry, comprises less than 50 ppm acrylic acid monomer.

14. The composition of claim 11, wherein said inorganic metal salt catalyst comprises ferrous sulfate.

15. The composition of claim 11, which, when dry, comprises no greater than 0.5 mg/in² chloroform-soluble extractives.

16. The composition of claim 11, which, when dry, comprises no greater than 0.1 mg/in² chloroform-soluble extractives.

17. A superabsorbent polymer prepared by drying the superabsorbent polymer precursor composition of claim 11.

18. A solution polymer comprising polyacrylic acid polymerized in the presence of ferrous sulfate catalyst, having a pH from 5.7 to 6.3, and a solids content of no greater than 50% by weight.

19. A method of making a superabsorbent polymer precursor composition, said method comprising:
polymerizing alpha,beta-ethylenically unsaturated monomers in the presence of inorganic metal salt catalyst to form an aqueous solution polymer composition; and
adjusting the pH of said composition to a pH of from 5.7 to 6.3.

20. The method of claim 19 further comprising
diluting said composition with water to a solids content of no greater than 10% by weight; and
adding a metal ion containing crosslinking agent.

21. The method of claim 20, wherein said metal ion containing crosslinking agent comprises ammonium zirconyl carbonate.

22. The method of claim 20, comprising adding no greater than 4% by weight said crosslinking agent.

23. The method of claim 20, wherein said composition, when cured, comprises less than 300 parts per million alpha,beta-ethylenically unsaturated carboxylic acid monomer.

24. An absorbent article comprising:
a substrate comprising fibers; and
a superabsorbent polymer formed from an aqueous superabsorbent polymer precursor composition comprising
at least partially neutralized polycarboxylated polymer,
inorganic metal salt catalyst, and
a metal ion containing crosslinking agent.

25. The absorbent article of claim 24, wherein said polycarboxylated polymer is prepared from acrylic acid monomer, and said absorbent article comprises no greater than 0.5 g/in² chloroform-soluble extractives and no greater than 300 ppm acrylic acid monomer.

26. Paper toweling comprising the absorbent article of claim 24, wherein said substrate comprises cellulose fibers.

27. The paper toweling of claim 26, further comprising a second substrate comprising cellulose fibers, said superabsorbent polymer being disposed between said first substrate and said second substrate.

28. The paper toweling of claim 26, wherein said superabsorbent polymer is in the form of a discontinuous pattern on the cellulose fiber substrate.

29. Cellulose tissue comprising a cellulose fiber web and a superabsorbent polymer derived from the composition of claim 11.

30. The absorbent article of claim 24, wherein said article exhibits a water absorbency that is at least 10% greater than the water absorbency of the article without the superabsorbent polymer composition.

31. The absorbent article of claim 24, comprising from 1% by weight to 10% by weight said superabsorbent polymer.

32. The absorbent article of claim 24, comprising from 1% by weight to about 8% by weight superabsorbent polymer.

33. The absorbent article of claim 24, wherein said substrate comprises a nonwoven web.

34. A method of making the absorbent article of claim 24 comprising:
a) contacting a substrate with a first composition comprising one of
i) an aqueous superabsorbent polymer composition comprising
at least partially neutralized polycarboxylated polymer, and
inorganic metal salt catalyst, and
ii) a metal ion containing crosslinking agent; and
b) contacting said substrate with a second composition comprising the other of
i) said aqueous superabsorbent polymer composition, and
ii) said metal ion containing crosslinking agent.

35. A food package comprising:
a food substance; and
the absorbent article of claim 24.

36. The food package of claim 31, wherein said food substance comprises at least one of meat, fish, fruit, and vegetables.

37. A method of making an absorbent article comprising:
contacting a substrate comprising fibers with an aqueous solution comprising a polymer derived from alpha,beta-ethylenically unsaturated monomers and inorganic metal salt catalyst, said solution having a pH of from about 7 to about 10; and
drying said substrate.

38. The method of claim 37, wherein said solution further comprises a metal ion containing crosslinking agent.
